(19) United States
(12) Patent Application Publication
(10) Pub. No.: US 2004/0054568 A1
(43) Pub. Date: Mar. 18, 2004

(54) Automated construction project estimator tool

(76) Inventors: Gary J. Bradley, Brighton, MI (US); Natalie Bradley, Brighton, MI (US)

Correspondence Address: HARNESS, DICKEY & PIERCE, P.L.C., P.O. BOX 828, BLOOMFIELD HILLS, MI, 48303, US

(21) Appl. No.: 10/610,353

(22) Filed: Jun. 30, 2003

Related U.S. Application Data
(60) Provisional application No. 60/393,138, filed on Jul. 1, 2002.

(51) Int. Cl. G06F 17/60

(52) U.S. Cl. 705/7

(57) ABSTRACT

A project resource quantification tool is adapted to estimate required amounts of components and/or connectivity materials for completing a construction project. An input receives an electronic image data file, such as a blueprint and/or schematic, containing project details. The input further receives an image feature, such as a symbol and/or run, relating to the image data file. The image feature has a classification based on correspondence of the image feature to a type of project resource, such as a type of component and/or connectivity material. A quantification module determines a total amount of the project resource, such as a total number of a type of component and/or a total length of a type of connectivity material, based on an identified relationship between the image feature and one or more regions of the image data file. An output, such as a summary report, specifies the total amount respective to the classification.

### CROSS-REFERENCE TO RELATED APPLICATIONS

This application claims the benefit of U.S. Provisional Application No. 60/393,138, filed on Jul. 1, 2002. The disclosure of the above application is incorporated herein by reference.

### FIELD OF THE INVENTION

The present invention generally relates to construction project estimation for bid formulation, and particularly relates to systems and methods of automated quantification of project components from an electronic blueprint, schematic, and/or other type of image data file.

### BACKGROUND OF THE INVENTION

The task of estimating a construction project from a set of blueprints or schematics is a complex undertaking. For example, persons attempting to estimate the project must shoulder two, primary responsibilities. Firstly, they must count each occurrence of a particular type of symbol within a given area of the blueprint or schematic. Secondly, they must determine from a scale of the drawing a total length of each type of material required to provide runs of connectivity between components within the project, such as electrical wiring, ventilation ducts, and plumbing. Further, they must assimilate the data and break it down by location of the project, alternates, and type of symbol or run, such as type of component or type of connectivity material.

Failure to accurately quantify numbers of components and/or lengths of runs is a frequent occurrence with dire consequences relating to bid formulation based on expected, total cost of construction materials. Failure to properly formulate a construction bid can lead to loss of funds due to underbidding, or loss of business due to overbidding. The same can be said of estimating cost of manufacture for small electrical equipment from schematics. Moreover, even where the quantification is performed accurately, the process of obtaining the quantification remains tedious and time consuming.

The need remains for a system and method that automatically extracts information from a blueprint, schematic, and/or other type of image data file and quantifies the total number of each type of component and/or total length of each type of run so that an accurate bid can be formulated with minimal expenditure of time and effort. The present invention fulfills this need.

### SUMMARY OF THE INVENTION

In accordance with the present invention, a project resource quantification tool is adapted to estimate required amounts of components and connectivity materials for completing a construction project. An input receives an electronic image data file, such as a blueprint and/or schematic, containing project details. The input further receives an image feature, such as a symbol and/or run, relating to the image data file. The image feature has a classification based on correspondence of the image feature to a type of project resource, such as a type of component and/or connectivity material. A quantification module determines a total amount of the project resource, such as a total number of a type of component and/or a total length of a type of connectivity material, based on an identified relationship between the image feature and one or more regions of the image data file. An output, such as a summary report, specifies the total amount with respect to the classification.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow diagram depicting an overview of the system flow in accordance with the present invention;

FIG. 2 is a block diagram depicting software components by domain in accordance with the present invention;

FIG. 3 is a screen shot illustrating the graphical user interface in accordance with the present invention;

FIG. 4 is a block diagram depicting user input components in accordance with the present invention; and

FIG. 5 is a block diagram depicting quantification, report generation, and editing components in accordance with the present invention.

### DETAILED DESCRIPTION OF THE PREFERRED EMBODIMENTS

The following description of the preferred embodiment(s) is merely exemplary in nature and is in no way intended to limit the invention, its application, or uses.

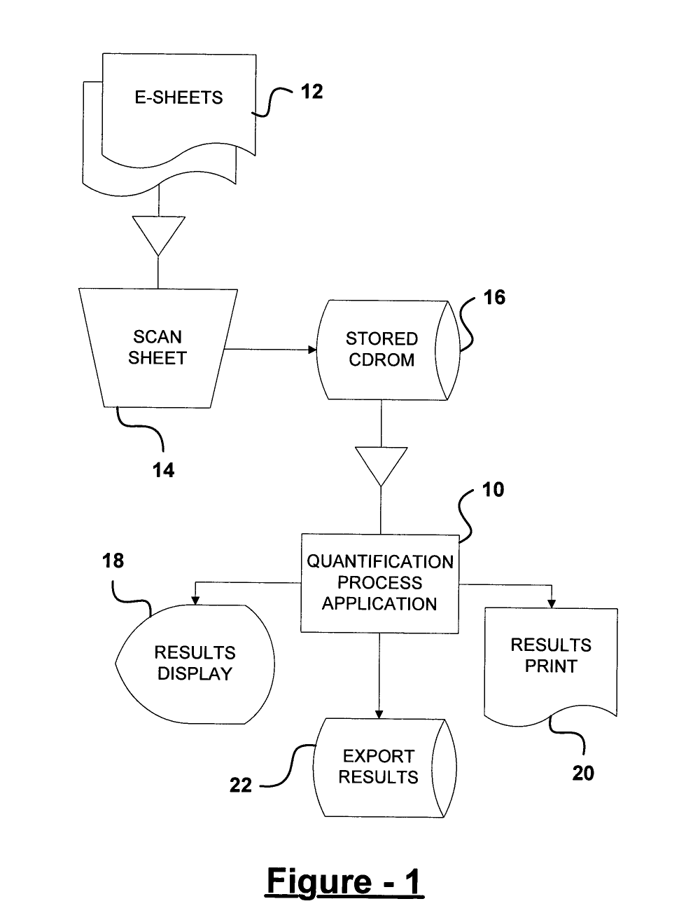

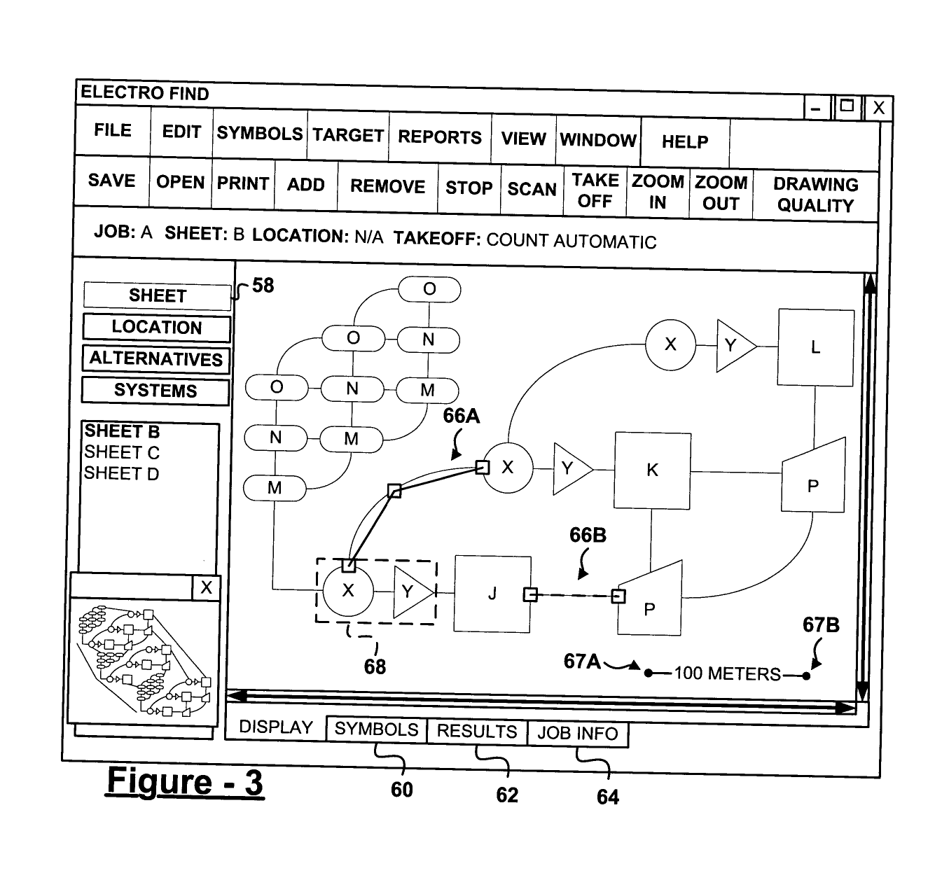

By way of overview, the system flow is illustrated in FIG. 1. Accordingly, the project estimator tool includes an automated quantification process application 10 for locating, identifying, and totaling symbols located in a project blueprint and/or quantifying total lengths of runs by class of run. Briefly, the application 10 is adapted to receive as input a scanned image of a project blueprint. A user fits portions of the blueprint as desired within a window to create a sheet, and provides location and/or alternates definitions as needed. The user also selects predefined symbols to be located in the document, and can further define symbols as needed based on document contents. The symbol definition process can be accomplished, for example, by clicking and dragging over an area of the displayed document as at 68 (FIG. 3). A symbol name and definition are provided by the user through a dialogue box. The document contents are extracted from the area selected by the user and employed as a model for locating similar symbols in the document. The size and shape of the selection serve as the size and shape of a visual indicator, such as a highlight, to be applied to portions of the document containing the similar symbols. The visual indicators for different types of symbols have different visual characteristics, such as highlight hue, to assist in identifying each type, or classification, of symbol.

The user further employs a dialogue box to define various types of runs with names and definitions based on types of required connectivity material, and uses the mouse to draw the runs in the window displaying the document. Accordingly, the user selects to draw a type of run and then clicks to add nodes, or handles, for a particular run. Edges are then applied automatically between the nodes according to a type of visual indicator specific to the run, such as a line thickness, line pattern, line color, and/or hue of highlight. Example runs having square handles and different line patterns are illustrated at 66A and 66B. The user still further provides a scale for each fitted sheet. The scale provision process can be accomplished, for example, by clicking once on either end of a scale contained in the displayed document as at 67A and 67B, and then providing measurement information, such as a scalar and units, through a dialogue box. Once the user has placed all of the runs, provided scales for each sheet of the job, and provided all of the symbols to the search set for all of the sheets of the job, the user can then call the search engine of application 10 (FIG. 1).

The application 10 scans the project blueprint to find each construction symbol as specified by the system user. The identified symbols are of each classification are counted and highlighted according to symbol type to indicate that they have been located and counted. Further, the application 10 finds for each classification of run the total length of all the runs of that type according to the scales for each sheet provided by the user. The user receives a summary report of the identified symbols and their corresponding counts by classification, sheet, location, and/or alternates as output from the application 10, along with total lengths for each classification of run, also broken down by sheet, location, and/or alternates. This output may in turn be used as input to an application that provides cost estimates relating to the project based on cost per component type and cost per unit of connectivity material type.

If the user is not satisfied with the outcome of the search, the user may edit the identification and location of symbols manually. For example, the user can manually add and delete symbols. Also, the user can select one or more misclassified symbols and manually reclassify them as symbols of another type. Further, the user may define more symbols, add more symbols to the search set, and recall the search. Still further, the user may exercise various search options, such as sequential versus concurrent search, as further explained below. Yet further still, the user can edit symbol properties, such as name, definition, highlight hue, size and shape, and masking as further explained below. Changes resulting from a manual or automatic edit of the search results are automatically reflected in the summary report.

Going now into more detail, features of the application 10 may include: symbol libraries containing the most commonly used symbols for each type of blueprint, the ability to find assemblies which are represented by multiple symbols in a specific configuration, the ability to add symbols to the available libraries, the ability to export the output data to other software products, the ability to control the sensitivity of the search process, and the ability to organize, label, and categorize each scanned blue print associated with a given project.

The system flow includes obtaining drawing sheets 12 from the customer, scanning each drawing as at 14 to produce one image file per drawing in a disk as at 16. In turn, application 10 performs the function of allowing a user to select an image file to use, such that the image file is displayed to the user on an active display. It also, permits the user to select a symbol set to find in the image, and/or to define runs of various classes within the image. It further permits the user to initiate a symbol search by passing symbol search control parameters to a search engine, and/or by passing defined runs to a run length computation engine. It yet further displays the search results and/or quantification results to the user as a marked-up image data file and/or summary report, and assigns descriptions to each symbol found in the file as appropriate. Yet further still, it permits users to reclassify symbols and/or assign like symbols to groups by multi-selecting the symbols and providing an assignment and/or classification selection. This multi-selection can be accomplished by holding down shift while clicking on the symbols, or by rubber band selecting an area containing the symbols with a diagonal click and drag. Additionally or alternatively, users can reclassify and/or assign symbols to groups one at a time. Finally, the result schedule of symbols classification quantities and/or run lengths and their descriptions can be displayed as at 18, saved, printed as at 20, and/or exported as at 22 by the user.

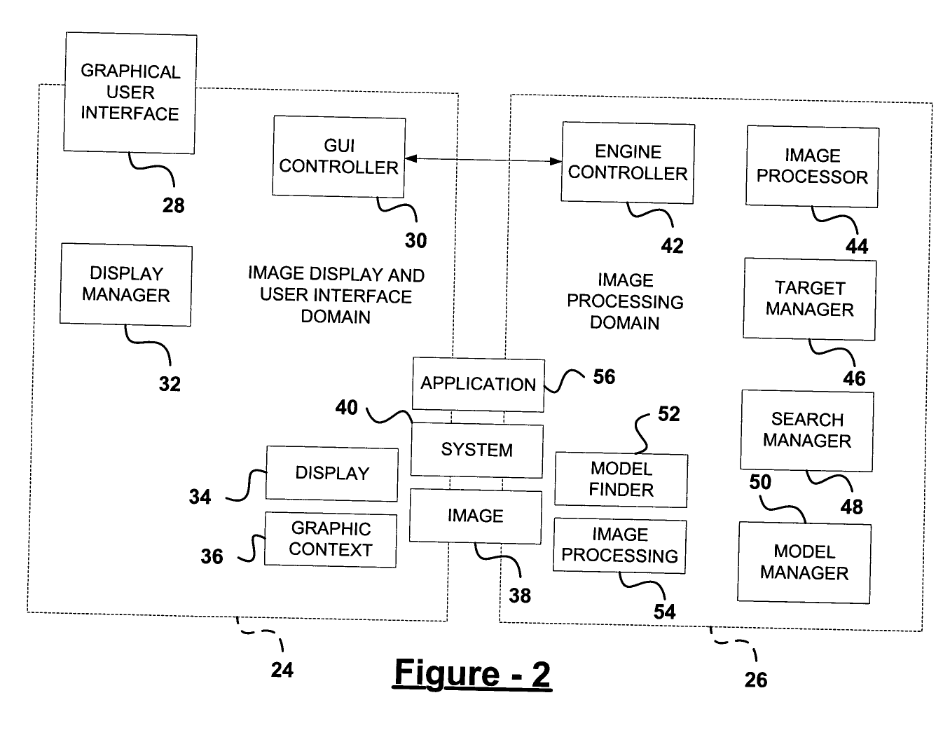

The system 40 is divided into two major domains as shown in FIG. 2. The image display and user interface domain 24 contains software objects and components that interact with the system user. For example, graphical user interface (GUI) 28 has a GUI controller 30 with a display manager 32 that displays graphic content of searchable images to the user via an active display. Also, GUI controller 30 allows the user to select options and control the search for symbols in those images, provide instructions to the image processing domain 26, and show results of the search when completed.

The image processing domain contains software objects that execute a search for symbols contained in the searchable drawing. These objects include, for example, engine controller 42, image processor 44, target manager 46, search manager 48, and model manager 50.

Both domains 24 and 26 use objects from the Matrox Image Library (MIL), such as model finder 52, image processing 54, application 56, system 40, image 38, display 34, and graphic context 36 objects. Some of these objects, application 56, system 40, and image 38 are shared between domains, while others are used exclusively in one domain or the other. MIL objects and accompanying software are commercially available from Matrox, Inc. Although MIL is presently preferred, it is envisioned that other types of image searching applications are within the scope of the present invention.

Each domain 24 and 26 contains a principal object that is the focus of its activity in that domain. These objects are referred to as controllers 30 and 42. The GUI controller 30 is the principle object of domain 24, and the engine controller 42 is the principal object in domain 26. Interactions between the domains 24 and 26 is restricted to interaction between the principal objects 30 and 42 in each domain. Domain 24 provides a set of objects and controls for the user to interface with the application as shown in FIG. 3. These objects allow the user to setup the job to be worked on, the sheets to be scanned, the definition and placement of runs, the symbols to be found, and the parameters for the actual scan. The activities are each a control that is defined within the system. For example, the sheet control 58 handles the displaying of an e-sheet, adding or deleting e-sheets, and cropping of an e-sheet. Also, the symbol control 60 provides the library of symbols both built and user defined. User defined symbols are brought in or created by the end-user by, for example, selecting a portion of the displayed sheet as at 68. All symbols have descriptive qualities that are managed by this control. Further, the results control 62, provides a reporting interface for viewing the output of searches. The results control 62 interfaces directly with the database. Still further, a run definition control (not shown) allows the user to define run classes and create runs on a sheet by adding graph nodes as at 66A and 66B. Still further, the job info control 64 presents the total number of each class and/or sub-class of found symbols and/or lengths of runs in the job in a spreadsheet format, with total numbers per class per sheet and other breakdowns of the information.

Beyond the controls, domain 24 uses standard Microsoft Windows Application Program Interfaces (APIs) for frames, menus, button bars, tabs, and windows. A true Microsoft standard is not held to because of the user audience's limited experience with computers. The objective of the interface is to drive the user through the process step by step, like an expert system.

Returning to FIG. 2, the engine controller object 42 of domain 26 is instantiated by the system at startup. It's function is to prepare, configure, and execute searchers for one of more model symbol images, or models, within a larger, searchable image, or target image. When the user, via the GUI controller 30, wishes to execute a search, the GUI controller makes a series of requests to the engine controller 42 that establish the parameters of the search. These parameters include the image to search, the set of models to search for, the region within the searchable image to search, and various other tuning and performance parameters that can be controlled by the user and the system. To process these parameters and to execute the search, the engine controller 42 makes use of several helper objects that sub-divide the image processing function.

The image processing domain 26 contains two types of objects: control and manager objects; and the embedded MIL objects that represent the bitmap searcher. The control and manager objects prepare the searchable image and the models for which to search, provide parameters, retrieve results, and control the embedded engine. The embedded bitmap searcher performs a low-level bitmap search, and finds designated symbol bitmaps in the larger drawing image bitmap. The controller and manager objects provide the unique personality for each search, tailoring it to the particular job at hand. The controller and manager objects render the search a tool to find particular symbols in drawings, rather than just one that finds small bitmaps in larger ones.

In performing its functions, the image processing domain performs a sequence of steps. For example, it receives parameters from the GUI control software, including identification and location of a drawing image to search, an identification and location of a symbols set for which to search, and other configuration values. Also, it preprocesses the image to search and the symbol set to search for. Further, it initiates the search by passing processed parameters to the embedded bitmap search engine, and waits for it to complete its search. Still further, it retrieves the search results from the embedded engine. Yet further still, it saves the results in a form associated with the image searched. Finally, it returns the results to the GUI controller 30 for further action.

The objects in the image processing domain 26 divide the functions of that domain into related packages. For example, the engine controller 42 is the principal object in domain 26, and is responsible for interacting with the GUI controller 30 in domain 24. It is responsible for dispatching work to other, helper objects in domain 26. The engine controller 42 and other objects in domain 26 share MIL objects with domain 24 and maintain certain key MIL objects separately: the model finder 52 and image processing objects 54. Also, the image processor 44 is responsible for manipulating searchable images to improve the efficiency of the search. Images can be smoothed, converted to different color schemes, and various other techniques can be employed to improve system function. Further, the target manager 46 is responsible for storing and retrieving images and converting them to searchable images appropriate to the MIL system. It can read raw images that have been scanned and placed on the computer's disk system. It converts these from standard commercial formats, such as JPEG, to a special MIL format that is more efficient for searching purposes. The present invention includes conversion software that converts TIFF, GIF, PNG, and BMP files into JPEG, and then converts them to MIL. Target manager 46 can further convert images in the other direction. Target manager 46 is also responsible for maintaining the relationships between results files and searched images as well as the versioning capabilities for multiple searches of the same image. Still further, search manager 48 is responsible for actually executing the search using the MIL objects. Finally, model manager 50 is responsible for maintaining the set of models to be searched for in any target image. These sets of models are standardized for various types of drawings, such that electrical or plumbing would have two different standard sets of models. Also, different drawing houses have different standard sets of symbols, and multiple representation of a symbols classification may be present in the standard set of models. For each search, the user can select which models from the available set are appropriate to the particular target image. For example, a drawing that contains only lighting symbols can be searched with a set of models that is restricted to lighting symbols, rather than all of the electrical symbols. Such a selection improves the speed of the search, and this speed can be further improved by restricting the search to symbols of the drawing house that prepared the sheet or sheets in question. The standard symbols sets can further be supplemented with user defined symbols.

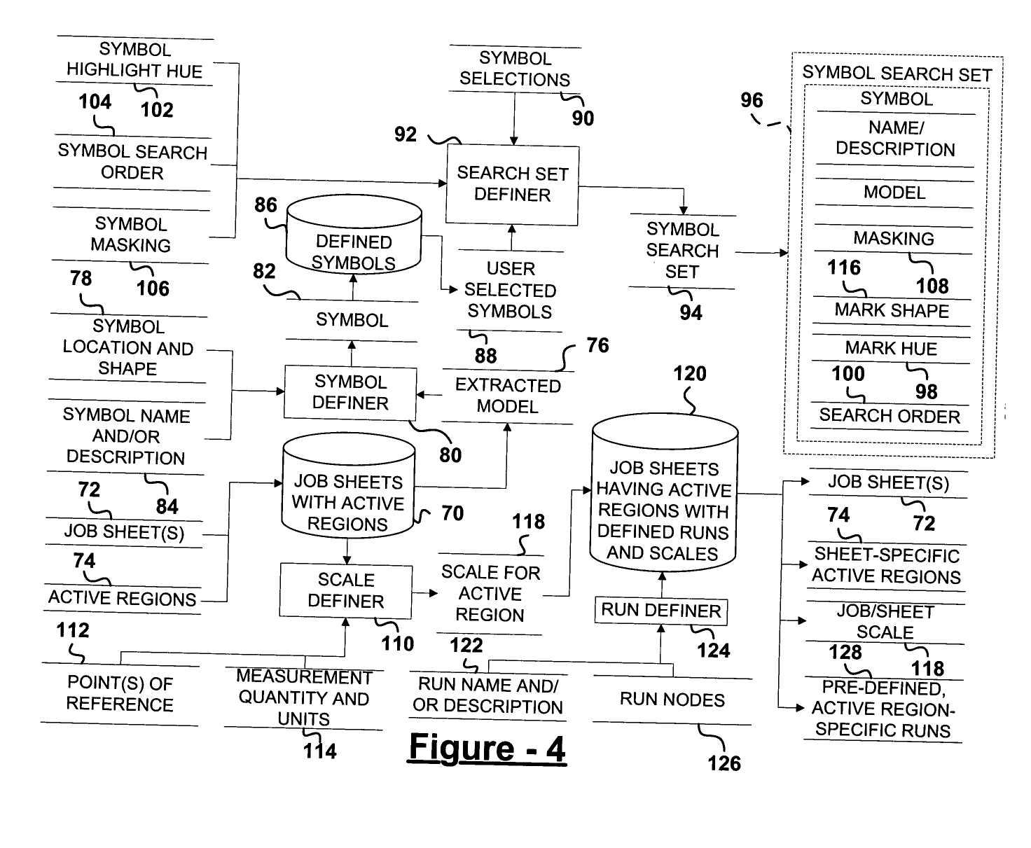

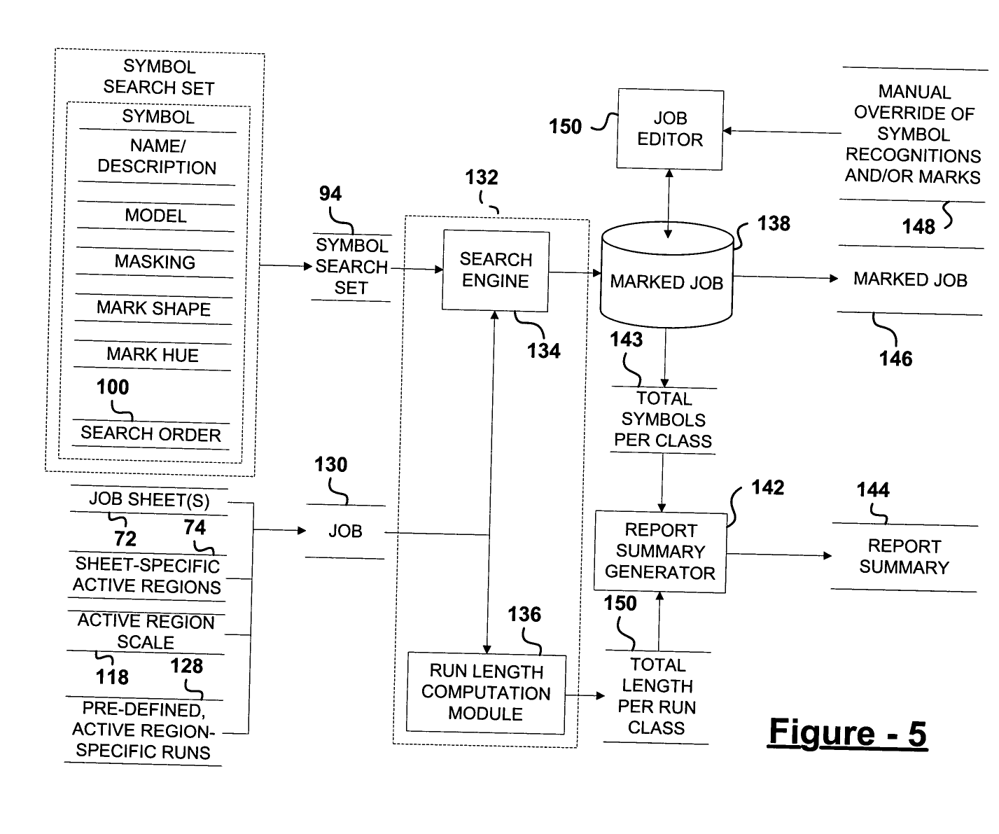

FIGS. 4 and 5 illustrate information flow and transformation through software modules implemented by combinations of software components of both domains of FIG. 2. FIG. 4 illustrates processes of the present invention that facilitate user interface with the electronic image data file before the automated search or run length computation. For example, job sheets datastore 70 stores drawing sheets 72 for a job with active regions 74 defined by the user when the sheets are oriented within and fitted to a viewing window. Also, the user can extract a symbol model 76 from a sheet of datastore 70 by specifying a symbol location and shape 78 within the sheet by, for example, selecting a portion of an active region related to the portion of the sheet by clicking and dragging over the displayed portion. Symbol definer 80 further allows the user to define the extracted model 76 as a symbol 82 by providing identifying information 84, such as a symbol name and/or description, and saving the defined symbol in datastore 86 of predefined symbols. Thus, other predefined symbols, such as those built for the user by a third party, can be supplemented by user-defined symbols.

The user can select pre-defined symbols 88 from datastore 86 by communicating symbol selections 90 to search set definer 92. In turn, definer 92 creates a symbol search set 94 by specifying for each symbol of the set 96 a default highlight hue 98 and search order 100. Preferably, definer 92 ensures that each symbol has a different hue of markup and that symbols are searched for in an order from most complex to least complex. However, the user may override these defaults by specifying a type of markup and a preferred search order. The user also edits the symbol as desired. For example, the user can alter the symbol model size and/or shape to improve recognition and/or markup accuracy. Also, the user can provide masking using, for example, an erasure tool that removes extraneous marks from the symbol. The resulting masking 108 may alternatively or additionally be applied based on confusability between symbols of the search set to remove portions of symbols that the symbols have in common. This process improves the symbol differentiation capability, and a tool is provided to the user so that the user can view the masking overlaying the symbol model and creatively provide masking to help differentiate between confusable symbols.

Scale definer allows the user to provide a scale for a fitted sheet by providing two points of reference 112 and a measurement quantity with units 114. For example, the user may click on two ends 67A and 67B (FIG. 3) of a scale present in the drawing, which allows definer 110 (FIG. 4) to extract the number of pixels in the active region between the two points. Thus, the quantity and units 114 can be related to the number of pixels to provide the scale. Alternatively, the user may click on two sides of a feature of known size, such as a door, to provide points of reference 112. In a further alternative, the user may indicate a measurement quantity and units, such as a horizontal or vertical width or an area, for a defined symbol located in the drawing and having a size and shape in terms of pixels and/or image position, which can provide at least two points of reference from its shape information 116.

With the scale 118 defined for the active region of a job sheet in datastore 120, it is possible for the user to define runs for the scaled sheet by providing run identifying information 122, such as a run name and description, to run definer, which in turn instantiates a class of run. Similarly to symbols of a search set, runs also have run classification specific markup, such as solid lines versus dashed lines, and/or such as highlight hue. Thus, when the user provides run nodes of a class of run by clicking in the active region of the displayed drawing, run definer 124 provides the edges between the nodes of the run according to the highlight, and stores the run in datastore 120. As a result, datastore 120 contains a marked-up job including job sheets 72, sheet-specific active regions 74, job sheet scale 118, and predefined, active-region-specific runs 128.

Turning now to FIG. 5, processes of the present invention are illustrated that provide automated and/or manual search functionality, run length computation, report generation, and manual override and reclassification functionality. For example, search set 94 and job 130 are passed to quantification module 132, which communicates job 130 to search engine 134 and run length computation module 136, and communicates search set 94 to search engine 134.

Search engine 134 searches for each symbol of search set in sheets 72 of job 130 by recursively rotating each masked symbol model while raster scanning through the job sheets 72. The user may have selected a sequential search, in which case the search proceed according to the search order 100, and later searches skip over areas of sheets identified as symbols in previous searches. Alternatively, the user may have selected a concurrent search, in which case the search proceeds to search every area of every sheet for every symbol, and resolves conflicts between different classes of symbols identified in a same sheet area by finding a best match for the area. The search engine also marks up the job in datastore 138 by highlighting each symbol according to its class-specific highlight and symbol shape, and fits the highlight shape to the angle of rotation at which the masked symbol model was found in the sheet. It is envisioned that alternative and/or additional forms of highlight may be employed, such as outline colors and/or patterns. Finally, search engine 134 records the total number of occurrences of each classification of symbol in datastore 138.

Run-length computation module 136 receives job 130, and computes total lengths 140 of classifications of runs based on the pixel-related lengths of classified runs 128 in the active regions, and pixel to unit quantity scales 118 for the active regions 74. Report summary generator 142 assembles the total number of symbols per class 143 and run lengths per class 140 in a report summary 144, such as a spreadsheet that breaks down the lengths and occurrences by classification and sheet and provides the symbol and run descriptions.

The user can review the marked job 146, and can further manually override symbol recognition and/or marks by manual input 148 to job editor 150. For example, the user can select one or more misclassified symbols and reclassify them. Also, the user can add or delete symbols separately or in groups. Symbols can be added quickly by clicking on symbols in the drawing and then selecting to add symbols of a class at those regions. Symbols of a particular class can alternatively be added one at a time as the user clicks on points in the sheet. It may further be necessary to correct a rotation angle of a found symbol or manually located symbol so that the markup shape is matched to the symbol's rotation angle in the drawing, and the user can provide this manual input as well. Job editor alters the marked job 146 in datastore 138, and these changers are reflected automatically in report summary 144 by generator 142.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A project resource quantification tool for estimating required amounts of components and connectivity materials for completing a construction project, comprising:
an input receptive of an electronic image data file containing project details, said input further receptive of an image feature relating to the image data file, wherein the image feature has a classification based on correspondence of the image feature to a type of project resource;
a quantification module adapted to determine a total amount of the project resource based on an identified relationship between the image feature and at least one region of the image data file; and
an output specifying the total amount with respect to the classification.

2. The quantification tool of claim 1, wherein said input is receptive of multiple image features having different classifications based on correspondence of the image features to different types of project resources, said quantification module is adapted to determine total amounts of the different types of project resources based on identified relationships between the image features and regions of the image data file, and said quantification module is adapted to apply visually distinctive indicators to the regions of the image data file that distinguish different types of project resources from one another.

3. The quantification tool of claim 1, further comprising:
a graphical user interface module adapted to display the image data file to the user, and to facilitate user definition of image features relating to the image data file; and
a symbol definition module adapted to permit the user to define an image feature corresponding to a symbol by extracting a model from a user-selected portion of the image data file, and recording a user-provided identification for the symbol based on correspondence of the model to a type of project component.

4. The quantification tool of claim 3, further comprising a search set definition module adapted to permit a user to define a search set of user-selected, predefined symbols, and to identify relationships between the symbols and regions of the image data file by searching the image data file for occurrences of members of the symbol set within the image data file.

5. The quantification tool of claim 2, further comprising a run definition module adapted to allow a user to define classifications of runs based on based on correspondence of runs to type of project connectivity material, and to identify a relationship between runs and regions of the image data file by instantiating occurrences of classified runs from point to point within the image data file.

6. The quantification tool of claim 5, wherein said run definition module is adapted to markup the image data file according to visually distinctive indicators assigned to different classifications of runs.

7. The quantification tool of claim 5, further comprising a scale definition module adapted to allow the user to specify a scale relating to the image data file.

8. The quantification tool of claim 6, wherein said scale definition module is adapted to permit a user to indicate two points of reference in the image data file, and to provide a measurement quantity and units relating to distance between the two points of reference.

9. The quantification tool of claim 7, wherein said quantification module is adapted to calculate a total length of all runs of a given classification according to the scale relating to the image data file.

10. The quantification tool of claim 2, further comprising a job editing module adapted to allow the user to select a classified image feature having an identified relationship with a region of image data file and to reclassify the image feature.

11. A project resource quantification method for estimating required amounts of components and connectivity materials for completing a construction project, comprising:
receiving a user selection relating to identification of a type of project resource designated in an electronic image data file containing project details;
identifying a relationship between an instance of the type of project resource and a region of the image data file; and
determining an amount of the type of project resource based on at least one relationship between at least one instance of the type of project resource and at least one region of the image data file.

12. The method of claim 11, further comprising:
receiving multiple user selections relating to identification of different types of project resources designated in an electronic image data file containing project details;
identifying relationships between instances of the different types of project resources and regions of the image data file;
determining total amounts of the different types of project resources based on relationships between instances of the different types of project resources and regions of the image data file; and
applying visually distinctive indicators to the regions of the image data file that distinguish different types of project resources from one another.

13. The method of claim 12, wherein said step of receiving a user selection relating to identification of a type of project resource includes receiving an identification of a type of connectivity material, said step of identifying a relationship between an instance of the project resource and a region of the image data file includes receiving a user selection of at least two points on a display of the image data file, and inferring presence of the connectivity material from point to point, and said determining an amount of the type of project resource includes calculating a total length between the points according to a scale relating the display of the image file to a predefined scale of image data file content.

14. The method of claim 13, further comprising:
receiving a user selection indicating at least two points of reference in the image data file, a measurement quantity, and units relating to distance between the two points of reference; and
determining the scale relating the display of the image file to the predefined scale of image data file content based on the points of reference, measurement quantity, and units.

15. The method of claim 13, wherein said applying visually distinctive indicators includes providing edges between the points according to visual characteristics assigned to different types of connectivity material.

16. The method of claim 13, further comprising:
calculating total lengths for all instances of each type of connectivity material related to the image data file; and
generating a report summarizing the total lengths for each type of connectivity material.

17. The method of claim 12, wherein said step of receiving a user selection relating to identification of a type of project resource includes receiving an identification of a type of component associated with a symbol model visually recognizable within the image data file, said step of identifying a relationship between an instance of the project resource and a region of the image data file includes, visually recognizing the symbol model within the region, and inferring presence of the type of component within the region based on the identification, and said determining an amount of the type of project resource includes calculating a total number of occurrences of the type of component within regions of the image data file.

18. The method of claim 17, further comprising:
defining a search set based on user selection of multiple symbol classifications identifying different types of components associated with different symbol models visually recognizable within the image data file;
searching the image data file to identify occurrences of multiple types of components within the image data file; and
generating a report summarizing total numbers of occurrences for each type of component.

19. The method of claim 17, further comprising permitting the user to define a classification of symbol by extracting a symbol model from a user-selected portion of the image data file, and recording a user-specified identification of a type of component in association with the symbol model.

20. The method of claim 12, further comprising allowing the user to select a region of the image data file visually related to a type of project resource and to reclassify the image feature as a different type of project resource.
